(19) United States
(12) Patent Application Publication
(10) Pub. No.: US 2026/0277882 A1
(43) Pub. Date: Sep. 17, 2026

(54) ENTITY MATCHING BY LARGE LANGUAGE MODELS WITH RUN TIME ANNOTATION

(71) Applicant: International Business Machines Corporation, Armonk, NY (US)

(72) Inventors: Ryo IWAKI, Sumida-ku (JP); Kohei MIYAGUCHI, Tokyo (JP); Takayuki OSOGAMI, Yamato-shi (JP)

(21) Appl. No.: 19/077,020

(22) Filed: Mar. 11, 2025

(51) Int. Cl. G06F 16/242; G06F 16/28

(52) U.S. Cl. CPC G06F 16/2428; G06F 16/288

(57) ABSTRACT

A computing device may select, at run time, a number of pairs of records from a plurality of records. Each record, of the plurality of records, includes attributes. The computing device may obtain, for each of the selected number of pairs of records, key attributes at run time. The computing device may provide, at run time, a prompt to a machine learning model to obtain a prediction of whether records, of a particular pair of records that is not selected from the records, are matched. The prompt may be generated based on the key attributes of the selected number of pairs of records.

### BACKGROUND

The present invention relates to entity matching, and for example, relates to entity matching by a large language model based on annotation regarding attributes and labels.

Entity matching is a process that compares records from different data sets to find matches. Entity matching may identify matches even when the data has different formatting or spelling. Entity matching may identify matches when the data has some similarities, but not exact matches.

### SUMMARY

A computer-implemented method, for entity matching using a large language model (LLM), may comprise selecting a number of pairs of records from a plurality of records, wherein each of the records includes attributes; obtaining, for each of the selected number of pairs of records, key attributes; and providing a prompt to the LLM to obtain a prediction of whether records of a particular pair of records are matched, wherein the prompt is generated based on the key attributes and the labels of the selected number of pairs of records.

A computer program product may comprise: one or more computer-readable storage media; and program instructions stored on the one or more computer readable storage media to perform operations comprising: selecting, at run time, a number of pairs of records from a plurality of records, wherein each record, of the plurality of records, includes attributes; obtaining, for each of the selected number of pairs of records, key attributes, values of the key attributes, and a label at run time, wherein a label, for a pair of records of the selected number of pairs of records, indicates whether records of the pair of records are matched based on key attributes in the records of the pair of records; and providing a prompt to a machine learning model to obtain a prediction of whether records, of a particular pair of records that is not selected from the records, are matched, wherein the prompt is generated, at run time, based on the key attributes, the values of the key attributes, and the labels of the selected number of pairs of records.

A computer system may comprise: one or more computer-readable storage media; a processor set; and program instructions stored on the one or more computer-readable storage media to cause the processor set to perform operations comprising: selecting a number of pairs of records from a plurality of records, wherein each record, of the plurality of records, includes attributes; obtaining, for each of the selected number of pairs of records, key attributes; generating a prompt based on the key attributes and the labels of the selected number of pairs of records; and providing the prompt to a machine learning model to obtain a prediction of whether records, of a particular pair of records that is not selected from the records, are matched.

### BRIEF DESCRIPTION OF THE DRAWINGS

FIG. 1 illustrates a block diagram of a computing environment described herein.

FIGS. 2A-2E are diagrams of an example implementation described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with entity matching using a large language model.

### DETAILED DESCRIPTION

The following detailed description of example implementations refers to the accompanying drawings. The same reference numbers in different drawings may identify the same or similar elements.

Entity matching (EM) is a process of identifying and linking records, in different data sets, that represent a same entity. The records may include types of information regarding entities. EM may be used for data wranglings. Data wrangling may refer to a process of cleaning, structuring, and transforming raw data into a usable format for analysis. In some situations, EM may be performed using a large language model (LLM). For example, the LLM may be provided with a prompt requesting the LLM to perform entity matching (e.g., to determine whether a pair of records match). The LLM may be hosted by a computing device. In this regard, the LLM may perform tasks (e.g., entity matching tasks) using computing resources of the computing device.

In some situations, a performance of the LLM may be improved when the LLM uses demonstrations. The LLM may learn new tasks when provided with demonstrations as part of the prompt. In the context of LLMs, a “demonstration” may be used to refer to a sample pair of an input and an output that is provided to the LLM as an example to guide an understanding of the LLM with respect to performing an entity matching task. In this regard, an effectiveness of the LLM may depend on a quality and relevance of the demonstrations provided to the LLM.

Currently, identifying quality and relevant demonstrations, for real world applications, is a complicated task. Accordingly, providing the LLM with demonstrations that are of subpar quality and that are not relevant may negatively affect a performance of the LLM. Because entity matching can be a complex computing task, providing demonstrations that are of subpar quality and that are not relevant may cause the LLM to consume a significant amount of the computing resources of the computing device. By consuming a significant amount of the computing resources, the LLM may delay a speed at which the computing device performs other tasks. Additionally, by consuming a significant amount of the computing resources, the LLM may prevent the computing device from performing other tasks.

Additionally, providing the LLM with demonstrations that are of subpar quality and that are not relevant may cause an accuracy of entity matching by the LLM to be reduced significantly. The reduction in accuracy causes the LLM to be retrained with additional training data. Therefore, the additional training data may be obtained and used to re-train the LLM. Obtaining additional training may consume a significant amount of data storage resources of the computing device. Additionally, obtaining additional training may consume network resources of the computing device that would have transmitted and/or received data for other tasks.

For at least the foregoing reasons, providing the LLM with demonstrations that are of subpar quality and that are not relevant may cause technical problems relating to computing resources, data storage resources, and network resources. In this regard, providing the LLM with demonstrations that are of subpar quality and that are not relevant may affect an efficient operation of the LLM and of the computing device.

Implementations described herein are directed to obtaining quality and relevant demonstrations at run time for LLM-based entity matching system. In other words, the demonstrations are not used to train an LLM when the system is being built but provided at run time to help perform an inference task of entity matching. In this regard, “at run time” may be used to refer to when the system is in operation as compared to when the system is being built/configured. As used herein, “quality and relevant demonstrations” may refer to demonstrations that include information that helps an LLM perform a task, thereby improving a performance of the LLM with respect to the task. The LLM may be hosted by a computing device.

In some examples, the demonstrations (described herein) may include pairs of records of entities and annotations (e.g., supplemental information) regarding the pairs of record. For example, for a pair of records, the annotations may include a label indicating whether the pair of records match and include key attributes used to determine whether the pair of records match. As used herein, an “attribute” may refer to information that describes an entity. In the context of a person/human as an entity, attributes of the entity may include a name, a date of birth (DOB), an address, a telephone number, a portion of a social security number (SSN), among other examples of information that identifies a person/human. In the context of an animal as an entity, attributes of the entity may include a cell structure, a movement, a type, a consumer habit, among other examples.

As used herein, a “key attribute” may refer to a subset of attributes of an entity that is used to determine whether a pair of records match. In the context of a person/human as an entity, key attributes of the entity may include a name, a date of birth, and a social security number. A label may indicate whether a match exists between two records.

In some implementations, the annotation may be provided by a user associated with the computing device. In this regard, implementations described herein use LLMs in an entity matching system that provides a user interface that may be used by the user to provide annotations regarding labels for pairs of records and regarding key attributes that are used to determine whether the records match. The annotations may include values of the key attributes. A prompt, provided to the LLM at run time, may include the labels, the values of the key attributes, and the key attributes along with demonstrations.

Because the user may have substantial knowledge regarding the records, the user may be in a position to provide annotations, for pairs of records, that are accurate. In some examples, good prompts may be generated semi-autonomously by a prompt manager of the computing device. Generating prompts semi-autonomously reduces involvement of the user. For example, after the user identifies, via the user interface, the attributes and the label, the prompt manager may identify frequently used key attributes. For example, the prompt manager may identify attributes that occur more frequently in the annotation. After identifying the frequently used attributes, the prompt manager may generate a prompt that includes the frequently used key attributes, the values of the frequently used key attributes, the labels, and the pairs or records that were annotated. The prompt may include a new pair of records and a request (for the LLM) to perform an entity matching task on the new pair of records.

In this regard, the prompt manager may generate and provide a prompt that includes demonstrations (including multiple pairs of records), frequently used key attributes, values of the key attributes, and labels associated with the frequently used key attributes. In some examples, the prompt manager may generate the prompt using a chain-of-thought prompt. By including the frequently used key attributes, the values, and the labels, implementations described herein improve the quality of the results of entity matching. With key attributes and value of the key attributes, the LLM can more accurately determine whether a pair of records match. When compared to other entity matching systems that require retraining LLMs after deployment, implementations described herein reduce an amount of computing resources that would have been to perform the entity matching process on the new pair of records. Implementations described herein do not involve retraining the LLM after the LLM has been deployed. Accordingly, implementations described may enable additional tasks to be performed during an inference performed by the LLM.

Additionally, implementations described herein may prevent obtaining additional training data to re-train the LLM, thereby preserving data storage resources that would have been used to store the additional training data. Additionally, implementations described herein may prevent requesting additional training data to re-train the LLM, thereby preserving data storage resources that would have been used to store the additional training data.

While examples herein discuss LLMs, other machine learning models may be used to as part of an entity matching process. Additionally, while examples herein discuss a chain-of-thought techniques, other techniques may be applicable herein. In some examples, implementations described herein may include a user preparing datasets to be matched. The user may input the prepared datasets to the EM system and the dataset may be stored in a database of the EM system. The user may initiate the EM system to cause the EM system to begin operation. During operation (e.g., at run time/during run time), a user interface may be provided to the user. The attributes, values of the attributes, and labels annotated by the user may be used in later operations (e.g., by specifying key attributes, composing prompts, and querying the LLM).

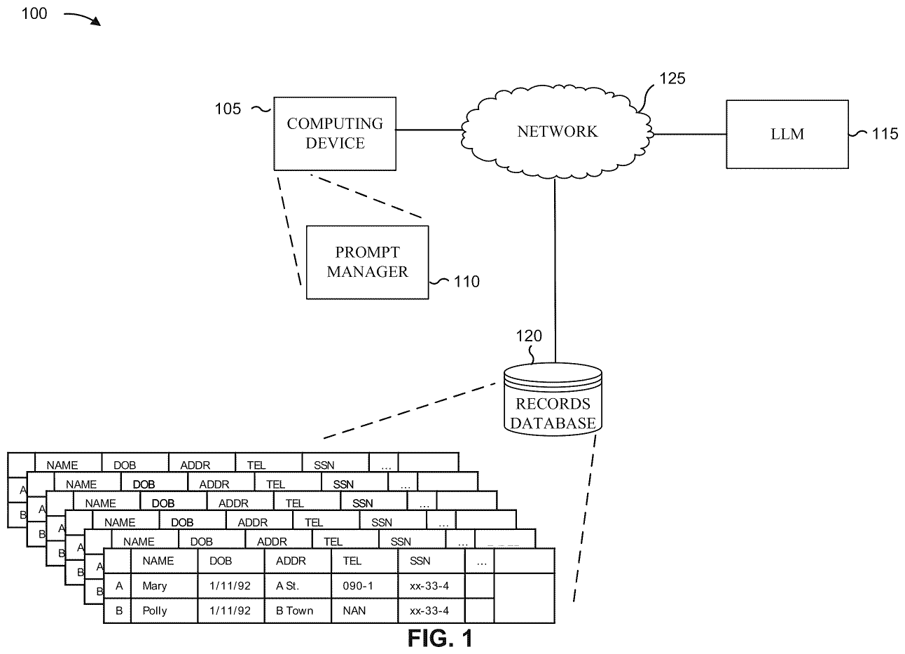

FIG. 1 illustrates a block diagram of a computing environment 100 for performing entity matching tasks. The computing environment 100 includes a computing device 105, an LLM 115, a records database 120, and a network 125. In some implementations, the computing device 105, the LLM 115, the records database 120 may be connected via network 125. In some implementations, one or more of the LLM 115 or the records database 120 may be included in the computing device 105. In some implementations, the computing device 105, the LLM 115, and the records database 120 may form an entity matching system.

The computing device 105 may encompass a wide range of computing systems and architectures. In some aspects, the computing device 105 may be part of a cloud computing infrastructure, which may include public, private, or hybrid cloud environments. Cloud computing devices may include virtualized resources, such as virtual machines or containers, running on physical hardware in data centers. In some implementations, the computing device 105 may be based on mainframe architectures. These systems may be designed for high-volume transaction processing and may include features like redundant components for high availability and reliability. Mainframe systems may be particularly suited for handling large-scale error management tasks due to their robust error detection and recovery capabilities.

The computing device 105 may include a distributed system, such as those based on microservices architectures. In these systems, applications may be broken down into smaller, independent services that communicate over a network. In some implementations, the computing device 105 may be an edge computing node, which process data closer to the source of data generation. In some implementations, the computing device 105 may include a mobile device, such as smartphones or tablets, which may act as both sources of error data and interfaces for system administrators to monitor, manage, and rectify errors remotely.

The computing device 105 contains a prompt manager 110, which is responsible for identifying frequently used key attributes and for generating and providing prompts to the LLM 115. The prompt manager 110 may be implemented as software running on the computing device 105, as a dedicated hardware component, or as a combination of hardware and software. In some embodiments, the prompt manager 110 may be distributed across multiple devices or implemented as a cloud-based service.

In some implementations, the prompt manager 110 may receive information identifying key attributes (e.g., identified by a user of the computing device 105) and may analyze the key attributes to identify frequently used key attributes. For example, the prompt manager 110 may identify frequently occurring attributes from information identifying key attributes. In some examples, the prompt manager may use a word frequency algorithm to identify top two most frequently occurring attributes, top three most frequently occurring attributes, and so on.

The prompt manager 110 may generate prompts using the frequently used attributes as described. For example, the prompts may include the frequently used attributes and labels associated with the frequently used attributes, along with demonstrations. In some implementations, the prompt manager 110 may generate the prompt using a chain-of-thought technique.

The LLM 115 may include a machine learning model that is trained to perform entity matching tasks. In some implementations, the training data may include different pairs of records and an indication, for each pair or records, indicating whether the pair of records match. In some examples, the LLM 115 may include a large language model.

The records database 120 may store information regarding different entities. In some implementations, the records database 120 may include a data store that stores records regarding different entities. As shown in FIG. 1, as an example, the records database 120 may store records regarding entities that are persons. For example, as shown in FIG. 1, a record may include different attributes, such as a name, a date of birth, an address, a telephone number, and a portion of a social security number. In some examples, the information stored by the records database may be anonymized to protect an identity of the person. In some examples, a record may be used as a demonstration for the LLM 115.

In some examples, the records database 120 may be implemented using various database technologies, such as relational databases, NoSQL databases, or graph databases, depending on the specific requirements of the system. In some examples, an entity matching task may be performed on the records of the records database 120 to remove duplicate records, thereby preserving the data storage resources of the records database 120. In some examples, an entity matching task may be performed on the records of the records database 120 to rectify/correct information regarding a person.

The network 125 may encompass a wide range of communication technologies and architectures to facilitate data exchange between the various components of the computing environment. In some implementations, the network 125 may include traditional wired networks, such as Ethernet-based local area networks (LANs) or fiber optic networks for high-speed, long-distance data transmission. These wired networks may provide reliable, high-bandwidth connections suitable for data-intensive error management tasks. Wireless technologies may also be incorporated into the network 125. For instance, Wi-Fi networks may enable flexible connectivity within office environments or data centers, while cellular networks, including 4G LTE or 5G, may support mobile devices or remote sensors in IoT scenarios. In some cases, the network 125 may leverage satellite communication systems to provide connectivity in remote or hard-to-reach locations.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

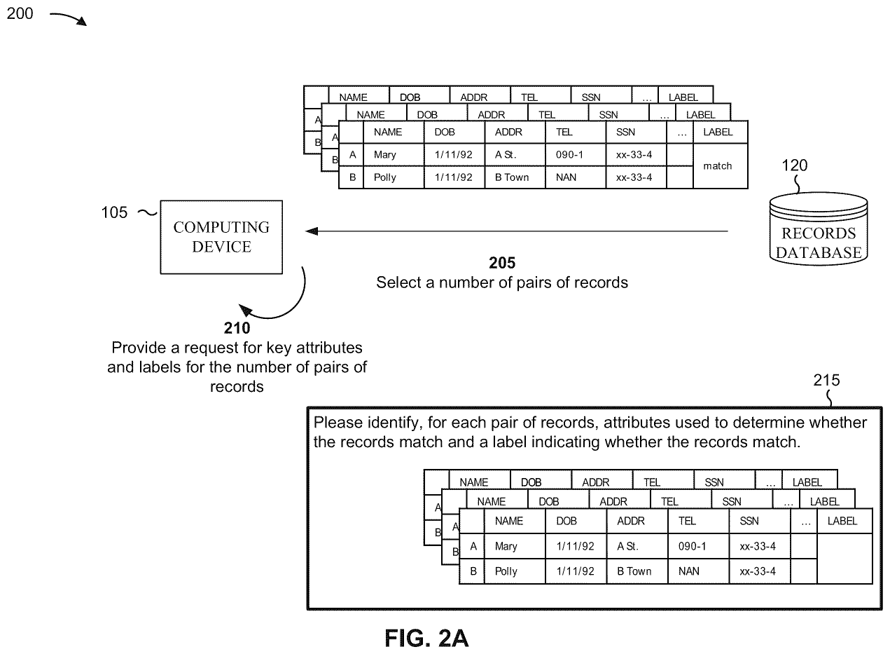

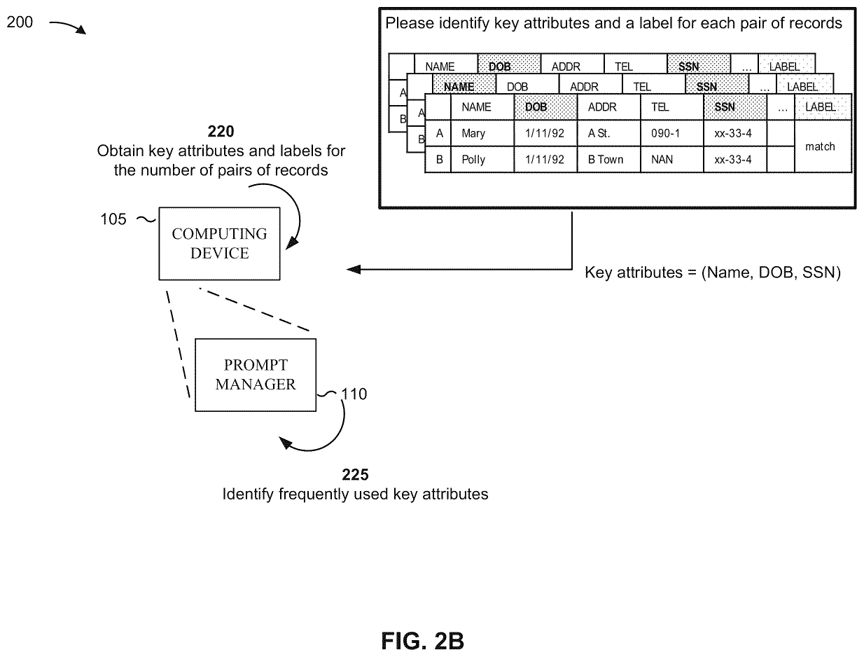

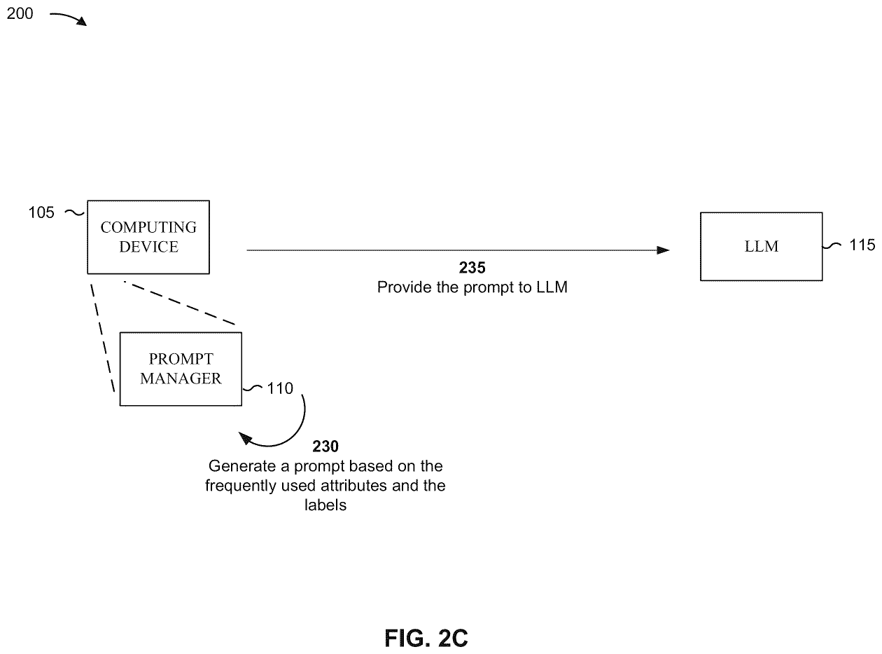

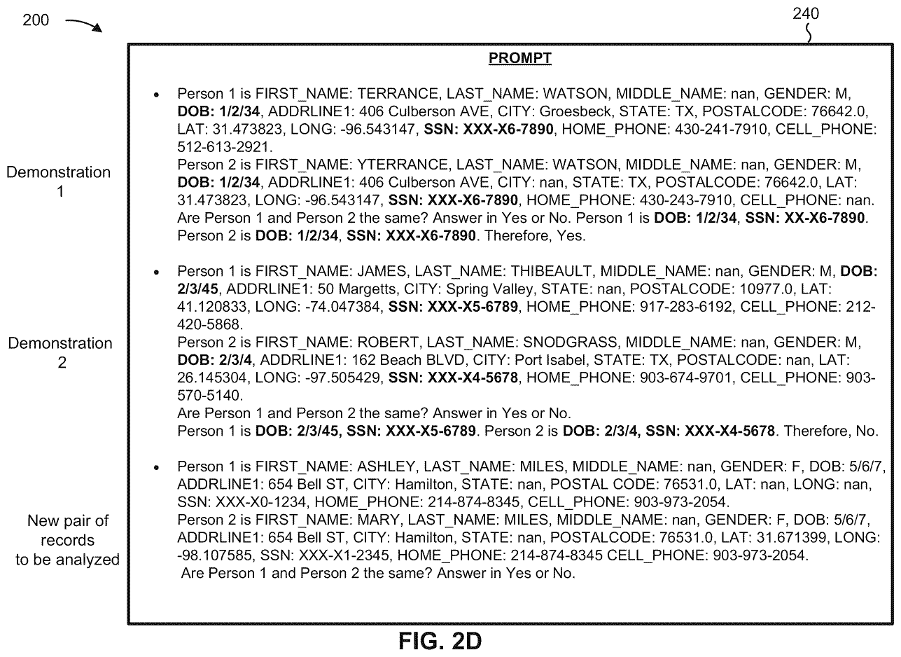

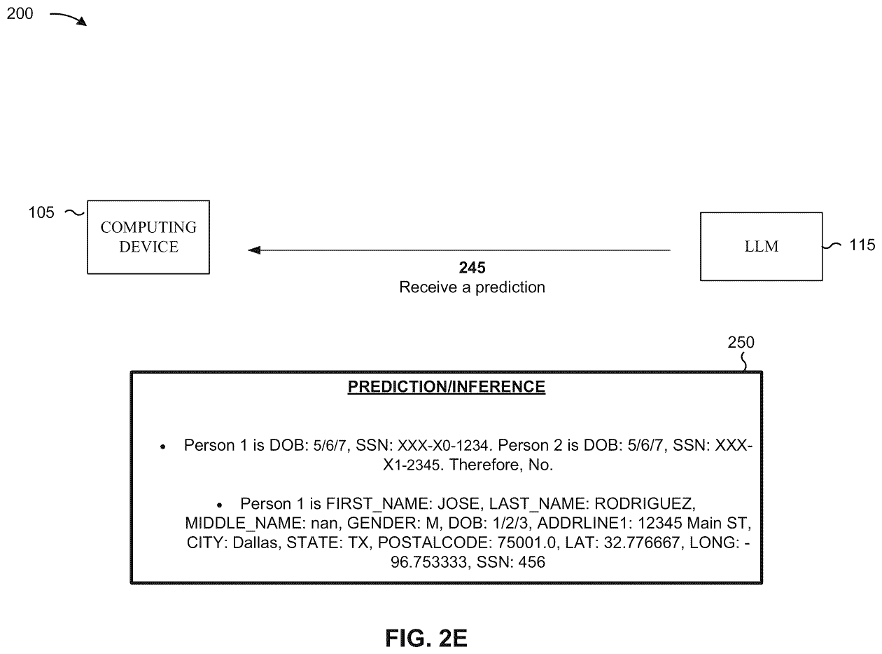

FIGS. 2A-2E are diagrams of an example implementation 200 described herein. As shown in FIGS. 2A-2E, example implementation 200 includes the computing device 105, the LLM 115, and the records database 120. As shown in FIG. 2A, and by reference number 205, the computing device 105 may select a number of pair of records. For example, the computing device 105 may provide a request for a number of pair of records to the records database 120 and receive the number of pairs of records from the records database 120. In some examples, the computing device 105 may sample a predetermined number of pairs of records uniformly at random from the records database 120, where the predetermined number is 100, for example. The predetermined number can be adjusted, but less than 10 may be too small (may miss some key attributes) and more than 1000 (may be too burdensome for users). In some examples, the request may be provided as part of an entity matching task to reduce an amount of data to be stored by an additional database, thereby reducing the data storage resources utilized by the additional database. Reducing the data storage resources may improve an efficiency of operation of the additional database (e.g., which respect to responding to requests for data and for storing data).

The number of pair of records may be a sample of records of the records stored by the records database 120. In some examples, the sample may have been previously identified by a user associated with the computing device 105 and/or the records database 120. In some examples, the number of records may be determined by the user associated with the computing device 105 and/or the records database 120. In some examples, the number of records may be a small portion of the records stored by the records database 120. For example, assume the records database 120 stores hundreds or thousands of records, the number of records may be ten or multiples of ten. The number of records may be chosen such that the user may analyze the pairs of records in a timely manner and/or in a manner to prevent the user from perceiving the analysis as a tedious task.

As shown in FIG. 2A, and by reference number 210, the computing device 105 may provide a request for key attributes and labels for the number of pairs of records. After receiving the number of pairs of records, the computing device 105 may generate and provide a user interface to a user associated with the computing device 105. The user interface may be provided at run time. In some examples, via the user interface, the computing device 105 may request that the user identifies the key attributes and labels for the number of pairs of records. As shown in FIG. 2A, the computing device 105 may provide a user interface 215. The user interface 215 may provide the number of pairs of records. Additionally, the user interface may provide a request to identify, for each pair of records, attributes used to determine whether the records match and a label indicating whether the records match.

As shown in FIG. 2B, and by reference number 220, the computing device 105 may obtain key attributes and labels from the number of pairs of records. For example, the user interface may receive inputs identifying the key attributes used to determine whether a match exist for each pair of records. As shown in FIG. 2B, the key attributes for a first record may include DOB and SSN and the label may indicate a match, the key attributes for a second record may include NAME and SSN and the label may indicate no match, the key attributes for a third record may include DOB and SSN and the label may indicate match, and so on. In this regard, the user interface may receive inputs indicating that the key attributes, for the number of pair of records, are NAME, DOB, and SSN. The computing device 105 may obtain the key attributes and labels for the number of pairs of records via the user interface. The computing device 105 may obtain input indicating the key attributes NAME and SSN occurred together once while the key attributes DOB and SSN occurred together twice. In some implementations, the computing device 105 may obtain values of the key attributes. For example, the computing device 105 may obtain values for NAME, DOB, and SSN.

As shown in FIG. 2B, and by reference number 225, the computing device 105 may identify frequently used key attributes. For example, prompt manager 110 may analyze the key attributes obtained via the user interface and may determine most frequently occurring key attributes. In some examples, the prompt manager 110 may use a word frequency algorithm to identify top two most frequently occurring attributes, top three most frequently occurring attributes, and so on. In the example herein, based on the input indicating the key attributes NAME and SSN occurred together once while the key attributes DOB and SSN occurred together twice, the prompt manager 110 may determine that the top two most frequently occurring attributes are DOB and SSN.

As shown in FIG. 2C, and by reference number 230, the computing device 105 may generate a prompt based on the frequently used attributes and the labels. For example, the computing device 105 may generate a prompt to cause the LLM 115 to perform an entity matching task on other records stored by the records database that were not selected. The prompt manager 110 may generate the prompt to initiate the entity matching task on the records of the records database 120 to remove duplicate records, thereby preserving the data storage resources of the records database 120. In some examples, the entity matching task may be performed on the records of the records database 120 to rectify/correct information regarding a person.

As shown in FIG. 2D, the computing device 105 may generate a prompt 240. In some examples, the prompt manager 110 may generate the prompt using a chain-of-thought prompting method. As shown in FIG. 2D, the prompt 240 may include two demonstrations, namely Demonstration 1 and Demonstration 2. In some examples, the pair of records of Demonstration 1 and the pair of records of Demonstration 2 may be included in the number of pairs of records selected by the computing device 105.

Demonstration 1 may include a first pair of records. Demonstration 1 may indicate that DOB and SSN were used to determine that the first pair of records are matched. For example, Demonstration 1 may indicate that the DOB and the SSN of a first record (of the first pair of records) matches the DOB and the SSN of a second record (of the first pair of records). Demonstration 1 may include values of the attributes DOB and SSN. In this regard, the values of the frequently used key attributes DOB and SSN for the first record match the values of the frequently used key attributes DOB and SSN for the second record. Accordingly, the first pair of records are matched. In other words, person 1 (identified by the first record) matches person 2 (identified by the second record).

Demonstration 2 may indicate that DOB and SSN were used to determine that the second pair of records are not matched. For example, Demonstration 2 may indicate that the DOB and the SSN of a third record (of the second pair of records) does not match the DOB and the SSN of a fourth record (of the second pair of records). Demonstration 2 may include values of the attributes DOB and SSN. In this regard, the values of the frequently used key attributes DOB and SSN for the third record do not match the values of the frequently used key attributes DOB and SSN for the fourth record. Accordingly, the second pair of records are not matched. In other words, person 1 (identified by the third record) does not match person 2 (identified by the fourth record).

As shown in FIG. 2D, the prompt 240 may include a new pair of records to be analyzed to determine whether the records match.

Referring back to FIG. 2C, and reference number 235, the computing device 105 may provide the prompt to the LLM. For example, the computing device 105 may provide the prompt to the LLM 115 to cause to perform an inference regarding the records, of the new pair of records, do match. In other words, the LLM 115 may generate a prediction indicating whether the records, of the new pair of records, do match. In some examples, the computing device 105 may provide the prompt 240 without detailed rules to use the frequently used key attributes when the LLM 115 is flexible enough to extract such rules implicitly. For example, LLM 115 may determine whether a pair of records match without detailed rules of exactly how the key attributes should be used to determine a match between records.

As shown in FIG. 2E, and by reference number 245, the computing device 105 may receive a prediction. For example, based on providing the prompt 240 to the LLM 115, the computing device 105 may receive a prediction from the LLM 115. The prediction may indicate whether the records, of the new pair of records, are matched. By providing the prompt with the frequently used key attributes and the labels with the demonstrations, the LLM 115 may receive quality and relevant demonstrations to facilitate the LLM 115 performing an inference.

As shown in FIG. 2E, the LLM 115 may generate a prediction 250. In some examples, with respect to the prediction 250, irrelevant text (e.g., with respect to entity matching) is also generated.

As indicated above, FIGS. 2A-2E are provided as an example. Other examples may differ from what is described with regard to FIGS. 2A-2E. There may be additional devices (e.g., a large number of devices), fewer devices, different devices, or differently arranged devices than those shown in FIGS. 2A-2E. Furthermore, two or more devices shown in FIGS. 2A-2E may be implemented within a single device, or a single device shown in FIGS. 2A-2E may be implemented as multiple, distributed devices. Additionally, or alternatively, a set of devices (e.g., one or more devices) shown in FIGS. 2A-2E may perform one or more functions described as being performed by another set of devices in FIGS. 2A-2E are.

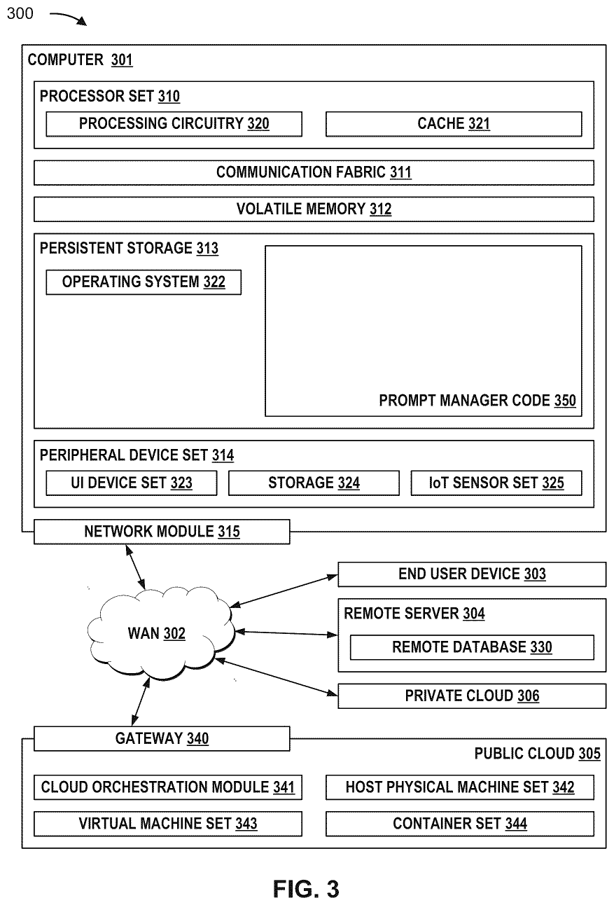

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as a prompt manager code, shown in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

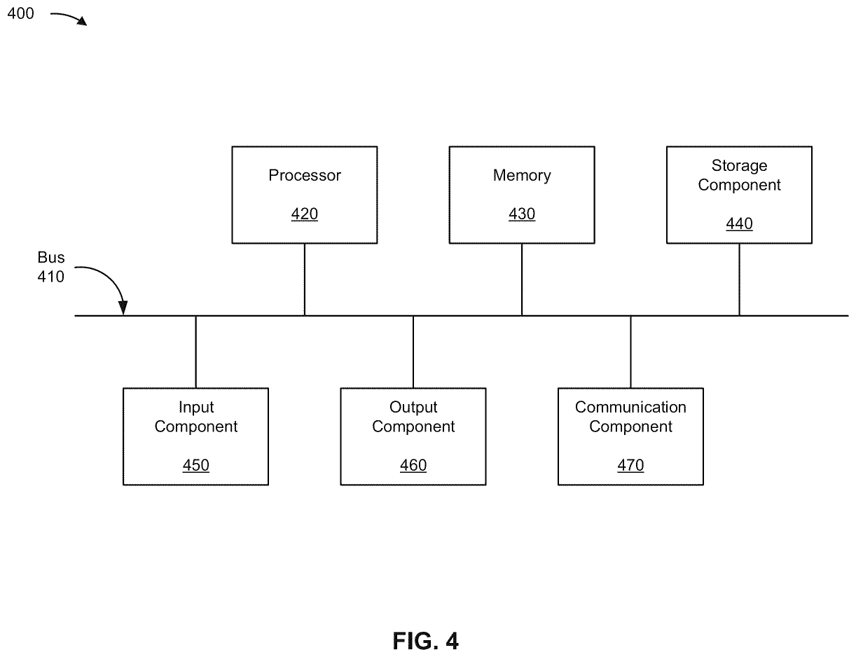

FIG. 4 is a diagram of example components of a device 400, which may implement one or more components of the computing environment 100. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

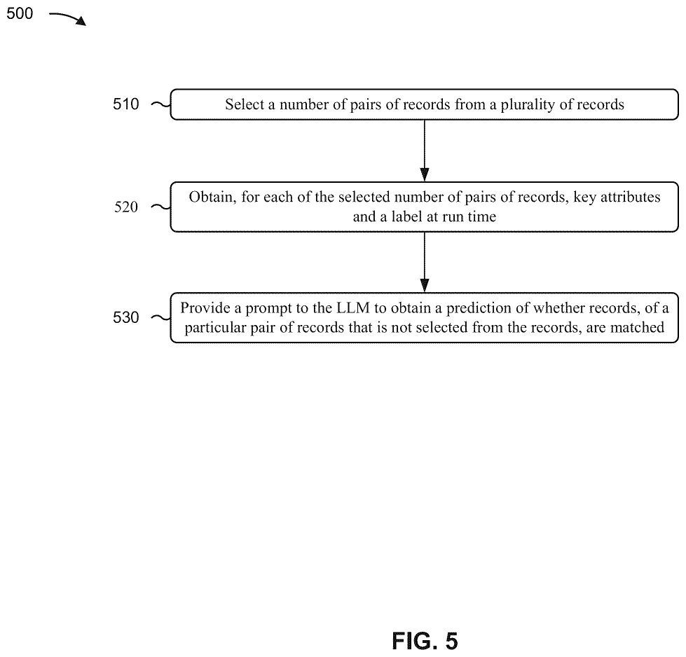

FIG. 5 is a flowchart of an example process 500 associated with entity matching using LLM as described herein. In some implementations, one or more process blocks of FIG. 5 may be performed by a computing device (e.g., the computing device 105). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include Select a number of pairs of records from a plurality of records (block 510).

As shown in FIG. 5, process 500 may include obtaining, for each of the selected number of pairs of records, key attributes and a label at run time (block 520).

As shown in FIG. 5, process 500 may include providing a prompt to the LLM to obtain a prediction of whether records, of a particular pair of records that is not selected from the records, are matched (at block 530).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A computer-implemented method for entity matching using a large language model (LLM), the computer-implemented method comprising:
selecting a number of pairs of records from a plurality of records, wherein each of the records includes attributes;
obtaining, for each of the selected number of pairs of records, key attributes;
identifying frequently used key attributes from the key attributes for each of the selected number of pairs of records;
generating a prompt based on the frequently used key attributes; and
providing the prompt to the LLM to obtain a prediction of whether records of a particular pair of records are matched.

2. The computer-implemented method of claim 1, further comprising:
providing a user interface at run time; and
obtaining the key attributes, for each of the selected number of pairs of records, at run time via the user interface.

3. The computer-implemented method of claim 1,
wherein the frequently used key attributes include a subset of the key attributes for each of the selected number of pairs of records.

4. The computer-implemented method of claim 3, further comprising:
obtaining labels associated with the frequently used key attributes; and
wherein the prompt is further generated based on the values of the frequently used key attributes, and the labels associated with the frequently used key attributes,
wherein the prompt includes the frequently used key attributes, the values of the frequently used key attributes, and the labels associated with the frequently used key attributes.

5. The computer-implemented method of claim 3, further comprising:
generating the prompt to include the records of the particular pair of records,
wherein the records, of the particular pair of records, include attributes different than the frequently used key attributes.

6. The computer-implemented method of claim 1, wherein providing the prompt comprises:
providing the prompt without providing one or more rules regarding a manner in which the key attributes are to be used to generate the prediction.

7. A computer program product comprising:
one or more computer-readable storage media; and
program instructions stored on the one or more computer readable storage media to perform operations comprising:
selecting, at run time, a number of pairs of records from a plurality of records,
wherein each record, of the plurality of records, includes attributes;
obtaining, for each of the selected number of pairs of records, key attributes, values of the key attributes, and a label at run time,
wherein a label, for a pair of records of the selected number of pairs of records, indicates whether records of the pair of records are matched based on key attributes in the records of the pair of records;
identifying frequently used key attributes from the key attributes for each of the selected number of pairs of records;
generating a prompt based on the frequently used key attributes; and
providing the prompt to a machine learning model to obtain a prediction of whether records, of a particular pair of records that is not selected from the records, are matched,
wherein the prompt is generated, at run time, based on the key attributes, the values of the key attributes, and labels of the selected number of pairs of records.

8. The computer program product of claim 7, wherein the operations further comprise:
generating the prompt using a chain-of-thought prompting method.

9. The computer program product of claim 7, wherein the operations further comprise:
providing the prompt without providing one or more rules regarding a manner in which the key attributes are to be used to generate the prediction.

10. The computer program product of claim 7,
wherein the frequently used key attributes include a subset of the key attributes for each of the selected number of pairs of records.

11. The computer program product of claim 10,
wherein the prompt is generated further based on the labels associated with the frequently used key attributes,
wherein the prompt includes the frequently used key attributes and the labels associated with the frequently used key attributes.

12. The computer program product of claim 7, wherein the operations further comprise:
providing a user interface at run time; and
obtaining the key attributes and the label, for each of the selected number of pairs of records, at run time via the user interface.

13. The computer program product of claim 7, wherein the operations further comprise:
generating the prompt to include the records of the particular pair of records,
wherein the records, of the particular pair of records, include attributes different than the key attributes.

14. The computer program product of claim 7, wherein the machine learning model includes a large language model (LLM).

15. A computer system comprising:
one or more computer-readable storage media;
a processor set; and
program instructions stored on the one or more computer-readable storage media to cause the processor set to perform operations comprising:
selecting a number of pairs of records from a plurality of records, wherein each record, of the plurality of records, includes attributes;
obtaining, for each of the selected number of pairs of records, key attributes;
identifying frequently used key attributes from the key attributes for each of the selected number of pairs of records;
generating a prompt based on the frequently used key attributes; and
providing the prompt to a machine learning model to obtain a prediction of whether records, of a particular pair of records that is not selected from the records, are matched.

16. The computer system of claim 15, wherein the operations further comprise:
providing a user interface at run time; and
obtaining the key attributes and a label, for each of the selected number of pairs of records, at run time via the user interface,
wherein a label, for a pair of records of the selected number of pairs of records, indicates whether records of the pair of records are matched based on key attributes in the records of the pair of records.

17. The computer system of claim 15, wherein the operations further comprise:
providing the prompt without providing one or more rules regarding a manner in which the key attributes are to be used to generate the prediction.

18. The computer system of claim 15, wherein, when generating the prompt, the processor set is to perform operations comprising:
generating the prompt to include the records of the particular pair of records,
wherein the records, of the particular pair of records, include attributes different than the key attributes.

19. The computer system of claim 15,
wherein the frequently used key attributes include a subset of the key attributes for each of the selected number of pairs of records.

20. The computer system of claim 19,
wherein the prompt is generated further based on attributes and labels associated with the frequently used key attributes,
wherein the prompt includes the frequently used key attributes and the labels associated with the frequently used key attributes.
